(19) United States
(12) Patent Application Publication
(10) Pub. No.: US 2009/0220249 A1
(43) Pub. Date: Sep. 3, 2009

(54) DEMODULATION CIRCUIT

(75) Inventor: Noriaki MIZUGUCHI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/388,938

(22) Filed: Feb. 19, 2009

(30) Foreign Application Priority Data
Feb. 28, 2008 (JP) 2008-048038

(51) Int. Cl. H04B 10/06; H04L 7/00; H04L 27/22

(52) U.S. Cl. 398/202; 375/354; 375/329

(57) ABSTRACT

A demodulation circuit for reproducing transmitted data from a signal received by a receiver, the demodulation circuit includes a selector, converters and data recovery circuits. The selector demultiplexes the transmitted data into a plurality of divided signals. The converters receives the divided signal from the selector, respectively, the plurality of converters including a delay device and an adding circuit, the delay device for delaying the divided signal from the selector and for outputting a delayed signal, the adding circuit for adding the divided signal from the selector to the delayed signal from the delay device. The plurality of data recovery circuits receives an output signal from the adding circuits, respectively, each of the data recovery circuits discriminating the output signal from the adding circuit.

### CROSS-REFERENCE TO RELATED APPLICATION

This application is based upon and claims the benefit of priority of the prior Japanese Patent Application No. 2008-048038, filed on Feb. 28, 2008, the entire contents of which are incorporated herein by reference.

### FIELD

The present invention relates to an RZ-MPSK demodulation circuit that receives and demodulates an RZ-MPSK (M=2n) signal, and a coding circuit that converts a code of a PCM code signal.

### BACKGROUND

In recent years, in an optical communication system, a modulation/demodulation technique such as DPSK (Differential Phase Shift Keying) or the like has been used. In DPSK, information is transported by phase variation between two symbols adjacent to each other. In binary DPSK (that is, DBPSK), phase variation between symbols is restricted to “o” or “π”. The system that uses four phase variations (0, π/2, π, 3π/2) is called as quaternary DPSK (that is, DQPSK). In DPSK, optical S/N ratio (OSNR: Optical Signal-to-Noise Ratio) is improved by 3 db and resistance to non linear effect is improved as compared with conventional binary amplitude shift keying (also referred to as OOK: On-Off Keying).

In optical DQPSK, a quaternary symbol is transmitted (that is, data of two bits is transmitted for one symbol), so that spectrum efficiency is doubled. Herewith, requirement for operational speed of an electrical device, adjustment of optical dispersion, and polarization mode dispersion are alleviated. That is, optical DQPSK is a major candidate of a next-generation optical communication system. Note that the structure and operation of an optical DQPSK transmitter/receiver are described in, for example, Japanese Laid-open Patent Publication No. 2004-516743 (International Publication Pamphlet No. WO2002/051041, US2004/008147).

FIG. 24 is a diagram illustrating a structural example of an optical DQPSK transmission system. An optical transmitter 200 illustrated in FIG. 24 is equipped with a DQPSK pre-coder 210, a light source 220, phase modulators 230A, 230B, and an intensity modulator 240. The DQPSK pre-coder 210 generates pair of data (data 1, data 2) from transmission data. The light source 220 generates CW light having a predetermined wavelength. The CW light is input to the phase modulators 230A, 230B. The pair of CW light input to the phase modulators 230A, 230B is controlled so that the phases are shifted by π/2 to each other.

The phase modulator 230A modulates the optical phase of the CW light generated by the light source 210 to “0” or “π” based on the data 1. The phase modulator 230B modulates the optical phase of the CW light to “π/2” or “3π/2” based on the data 2. An optical DQPSK signal can be obtained by combining the output signals of the phase modulators 230A, 230B. RZ intensity modulation is performed with respect to the optical DQPSK signal by the intensity modulator 240, and thereafter transmitted to an optical transmission path 401. With the structure, the optical RZ-DQPSK signal is transmitted to the optical transmission path 401. The optical transmission path 401 is a WDM (Wavelength Division Multiplexing) line.

In the embodiment, an optical WDM circuit 402, an optical amplifier (AMP), and a separation circuit 403 for separating WDM light for every wavelength are provided on the optical transmission path 401. Further, in the embodiment, an optical dispersion compensator (ODC) 404 is provided at the pre-stage of the optical receiver 300. Generally, optical S/N ratio is deteriorated in the optical amplifier, and wavelength dispersion and polarization mode dispersion are generated in optical fiver long distance transmission. The ODC mainly compensates primary dispersion to an operation amount.

The optical receiver 300 is equipped with delay interferometers 310A, 310B, balanced optical detectors (TWIN-PD) 320A, 320B, discrimination circuits 330A, 330B, a decoder 340, and a control circuit 350. Then, the optical DQPSK signal is branched and provided to the delay interferometers 310A, 310B.

The delay interferometer 310A outputs the interferometer signal of the signal obtained by delaying the optical RZ-DQPSK signal by one symbol time and the signal obtained by shifting the phase of the optical RZ-DQPSK signal by π/4. On the other hand, the delay interferometer 310B outputs the interferometer signal of the signal obtained by delaying the optical RZ-DQPSK signal by one symbol time and the signal obtained by shifting the phase of the optical RZ-DQPSK signal by −π/4. Each of the balanced optical detectors 320A, 320B converts the output optical signal of the delay interferometer 310A, 310B to an electrical signal. The pair of the electrical signals obtained with the structure is an intensity modulation signal (herein, RZ code signal).

The discrimination circuits (e.g. data recovery circuits) 330A, 330B respectively recover data (I channel signal, Q channel signal) from the signals obtained by the optical detectors 320A, 320B. The decoder 340 performs a bit exchange processing that corresponds to a processing of the DQPSK pre-coder with respect to the I channel signal and the Q channel signal. The control circuit 350 adjusts phase elements of the delay interferometers 310A, 310B to targeted values (π/4, −π/4). Herewith, transmission data is recovered.

FIG. 25 is a diagram illustrating an operation of the data recovery circuit. The data recovery circuit discriminates whether that each bit of the input signal is “0” or “1” by using a clock signal having a predetermined frequency. When a clock signal 1 having the same frequency as that of the bit-rate is used, the signal is discriminated by the rising edge of the clock signal 1. Further, when a clock signal 2 having the frequency that is one-half of that of the bit-rate is used, the signal is discriminated by the both of rising edge and falling edge.

A linear amplifier 351 and an equalizer 352 may be provided between each of the optical detectors 320A, 320B and the data recovery circuits 330A, 330B as illustrated in FIG. 26. The equalizer 352 equalizes dispersion of the optical signal and provides an EDC function. Further, the equalizer 352 may be equipped with an amplification function.

Note that, a receiving circuit that reproduces data by precisely discriminating a signal transmitted with the DQPSK signal is described in Japanese Laid-open Patent Publication No. 2007-60443.

Speeding up of a transmission rate in an optical communication system has been rapidly progressed. For example, when 43 Gbps data is transmitted by a DQPSK system, the bit rates of an I channel and a Q channel respectively become 21.5 Gbps.

However, speeding up of a circuit that processes an electric signal in a receiver is not sufficient. That is, it is not easy to provide the equalizer that performs filtering on the aforementioned high-speed data. As an example, in ITU standard, “bit-rate×0.75 [Hz]” is recommended as a treble cutoff frequency of a filter that equalizes an NRZ intensity modulation signal. However, it is not easy to provide such an equalizer for high speed. Consequently, noise can not be fully removed, causing deterioration of S/N ratio. Further, it is also not easy to provide a data recovery circuit that discriminates the high-speed data as described above. For example, when bit rate is increased, resistance to waveform distortion is lowered.

As a result, probability that false discrimination is performed in the data recovery circuit is increased. Specifically, when generated dispersion is not fully compensated in an optical transmission path, error rate is deteriorated.

### SUMMARY

According to an aspect of the embodiment, a demodulation circuit for reproducing transmitted data from a signal received by a receiver, the demodulation circuit includes a selector, converters and data recovery circuits.

The selector demultiplexes the transmitted data into a plurality of divided signals.

The converters receives the divided signal from the selector, respectively, the plurality of converters including a delay device and an adding circuit, the delay device for delaying the divided signal from the selector and for outputting a delayed signal, the adding circuit for adding the divided signal from the selector to the delayed signals from the delay elements.

The plurality of data recovery circuits receives an output signal from the adding circuits, respectively, each of the data recovery circuits discriminating the output signal from the adding circuit.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a structure of a demodulation circuit according to a first example.

FIGS. 2A-2E are first diagrams illustrating an operation of the demodulation circuit of an embodiment.

FIGS. 3A-3G are second diagrams illustrating an operation of the demodulation circuit of the embodiment.

FIG. 4 is a first eye diagram of a waveform response of the demodulation circuit.

FIG. 5 is a second eye diagram of a waveform response of the demodulation circuit.

FIG. 6 is a third eye diagram of a waveform response of the demodulation circuit.

FIG. 7 is a first eye diagram in the case where an input waveform is distorted.

FIG. 8 is a second eye diagram in the case where an input waveform is distorted.

FIG. 9 is a third eye diagram in the case where an input waveform is distorted.

FIG. 10 is a first eye diagram in the case where there is polarized wave dispersion.

FIG. 11 is a second eye diagram in the case where there is polarized wave dispersion.

FIG. 12 is a third eye diagram in the case where there is polarized wave dispersion.

FIG. 13 is a diagram illustrating a structure of a demodulation circuit according to a second example.

FIG. 14 is a diagram illustrating a structure of a demodulation circuit according to a third example.

FIG. 15 is a diagram illustrating a structure of a demodulation circuit according to a fourth example.

FIG. 16 is a diagram illustrating a structure of a demodulation circuit according to a fifth example.

FIG. 17 is a diagram illustrating a structure of a demodulation circuit according to a sixth example.

FIG. 18 is a diagram illustrating a structure of a demodulation circuit according to a seventh example.

FIG. 19 is a diagram illustrating an optical receiver equipped with the demodulation circuit of the embodiment.

FIG. 20 is a diagram illustrating a constituent example of another optical receiver equipped with the demodulation circuit of the embodiment.

FIGS. 21A and 21B are diagrams illustrating a PCM code signal used in a coding circuit of the embodiment.

FIG. 22 is a first diagram illustrating an operation of the coding circuit of the embodiment.

FIG. 23 is a second diagram illustrating an operation of the coding circuit of the embodiment.

FIG. 24 is a constituent example of an optical DQPSK transmission system.

FIG. 25 is a diagram illustrating an operation of a data recovery circuit.

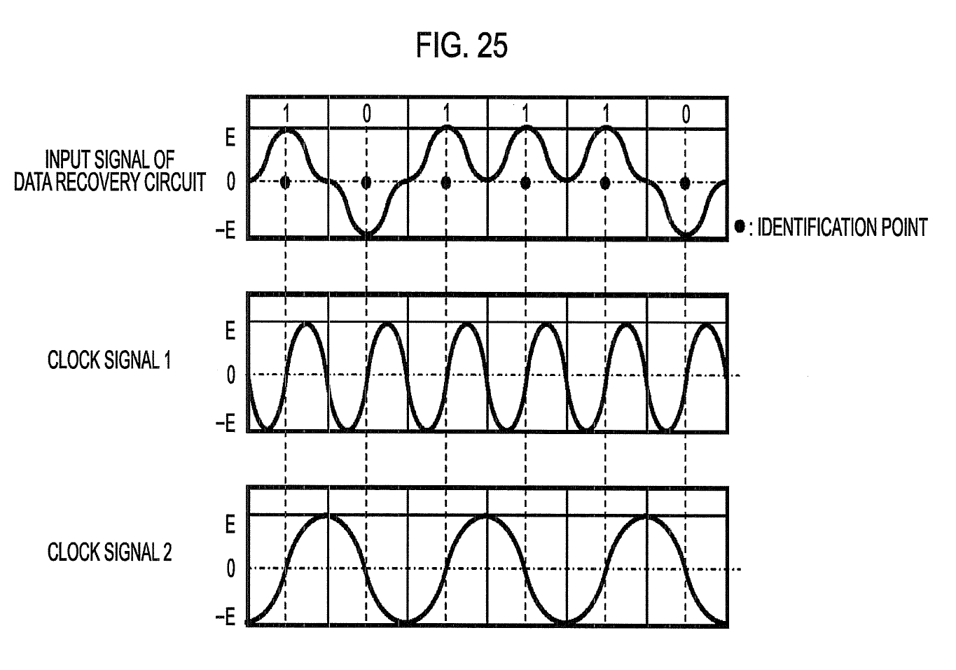

FIG. 26 is a diagram illustrating a constituent example of a conventional demodulation circuit.

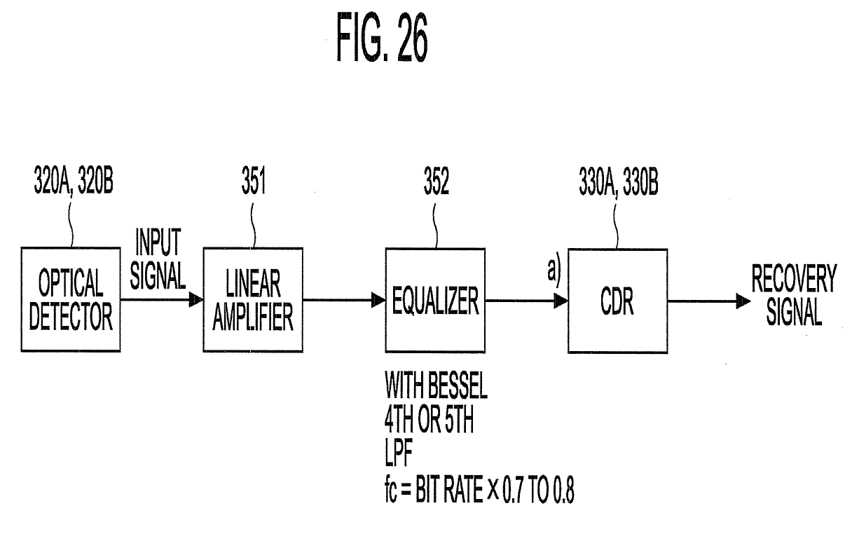

### DESCRIPTION OF EMBODIMENTS

A demodulation circuit of an embodiment is used in an optical receiver that recovers transmission data from an optical RZ-PSK signal. Herein, the RZ-PSK signal shall include an RZ-2ⁿPSK signal and an RZ=D2ⁿPSK signal. “n” is an integer number. For example, “n=1” corresponds to an RZ-BPSK signal or an RZ-DBPSK signal, and “n=2” corresponds to an RZ-QPSK signal or an RZ-DQPSK signal.

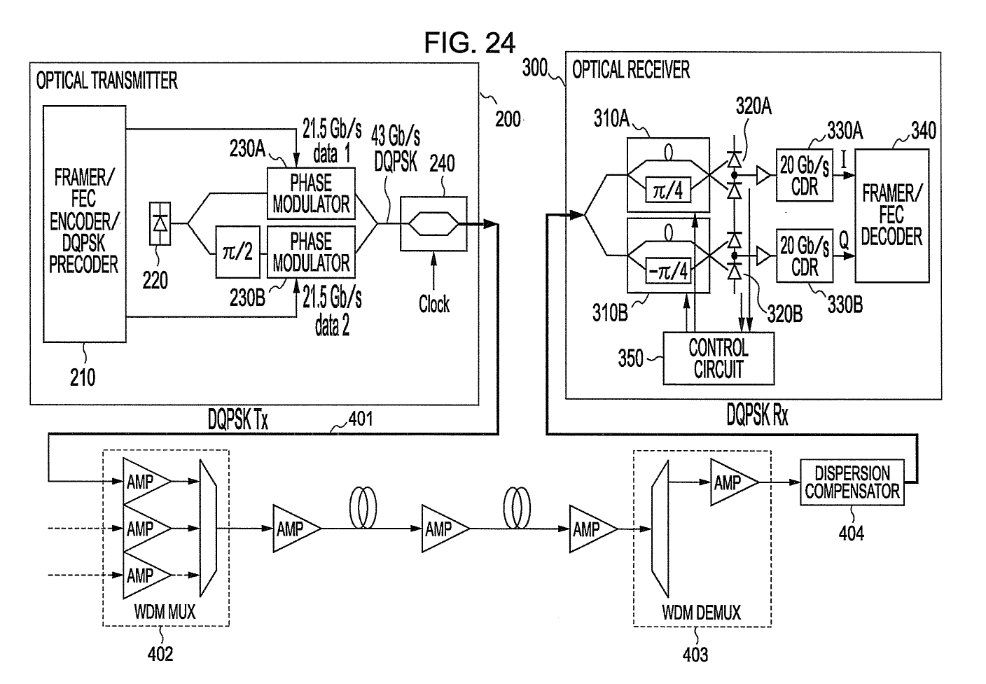

The optical receiver of the embodiment is, for example, an optical receiver 300 that is used in an optical DQPSK transmission system illustrated in FIG. 24. That is, the optical receiver of the embodiment receives an optical RZ-DQPSK signal transmitted from an optical transmitter 200. Herein, as described above, the optical transmitter 200 generates an optical DQPSK signal based on transmission data and generates an optical RZ-DQPSK signal by demodulating the intensity of the optical DQPSK signal. An intensity modulator 240 varies the intensity of the optical DQPSK signal so that, for example, electric power at the start and end of a symbol period becomes zero and the electric power becomes the maximum in the intermediate area for every symbol period. As an example, the intensive modulation is performed so that the transmission power in each symbol period is proportional to sin θ (θ=0 to π).

The optical receiver receives the optical RZ-DQPSK signal generated as described above. The optical RZ-DQPSK signal is, as illustrated in FIG. 24, branched and introduced into a pair of optical delay interferometers 310A, 310B. An optical signal output from the optical delay interferometer 310A is converted to an analog electric signal by an optical detector 320A, and an optical signal output from the optical delay interferometer 310B is converted to an analog electric signal by an optical detector 320B.

Demodulation circuits of the embodiment demodulate the analog electric signals detected by the aforementioned optical detectors 320A, 320B to recover data. Herein, structures and operations of the demodulation circuit that recovers data from the output signal of the optical detector 320A and the demodulation circuit that recovers data from the output signal of the optical detector 320B are basically the same to each other.

### First Embodiment

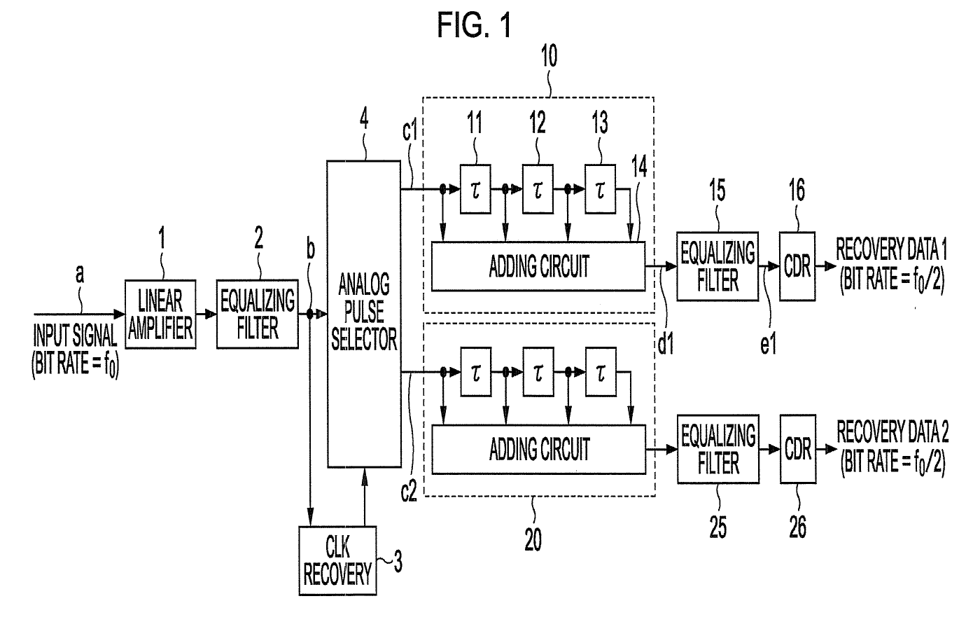

FIG. 1 is a diagram illustrating a structure of a demodulation circuit of a first example. The demodulation circuit is, as described above, for example, provided in the optical receiver 300 illustrated in FIG. 24. Then, an input signal of the demodulation circuit is an analog electric signal a detected by the optical detector 320A (or, 320B). Note that the bit rate of data transmitted by the input signal shall be “f₀”.

A linear amplifier 1 linearly amplifies the signal a. An equalizing filter 2 performs filtering on an output signal of the linear amplifier 1. The equalizing filter 2 is, for example, is a 4th or 5th order low-pass Thomson or Bessel filter, and the cutoff frequency (that is, treble cutoff frequency) is “f₀×0.7 to 0.8”. A clock recovery circuit 3 recovers a clock signal by using a signal b output from the equalizing filter 2. The frequency of the clock signal to be recovered is, for example, “f₀” or “f₀/2”. However, the frequency of the clock signal which should be recovered is not particularly limited as far as the signal can be appropriately separated in an analog pulse selector 4.

The analog pulse selector 4 is a 1:2 demultiplexer, and separates the signal b output from the equalizing filter 2 by time division and generates a signal C1 and a signal c2. Convertor (delay adding circuits) 10, 20 are provided at the post-stage of the analog pulse selector 4. Then, the analog pulse selector 4 leads the signals c1, c2 to the delay adding circuits 10, 20 respectively. That is, the signal c1, c2 is input to the delay adding circuit 10 and the signal c2 is input to the delay adding circuit 20.

The delay adding circuit 10 is equipped with delay elements 11 to 13 and an adding circuit 14. The delay elements 11 to 13 form a delay device. The signal c1 is provided to the adding circuit 14 and also provided to the delay element 11. The delay elements 11 to 13 are connected in series connection and create “signal c1(c1+τ) delayed by τ”, “signal c1(c1+2τ) delayed by 2τ”, “signal c1(c1+3τ) delayed by 3τ”. Output signals of the delay elements 11 to 13 are provided to the adding circuit 14. That is, the four signals (c1, c1+τ, c1+2τ, c1+3τ) are provided to the adding circuit 14. Then, the adding circuit 14 adds the four signals to generate a signal d1. Note that the delay time τ is one-half of the one bit time in the example. That is, the delay time is defined by “τ=(1/f₀)×(½)”. Further, each delay element 11 to 13 is provided by a conductor line that transmits an electrical signal, and the delay time τ is provided by appropriately setting the length of the conductor line.

The structure and operation of the delay adding circuit 20 are the same as in the delay adding circuit 10. Accordingly, the delay adding circuit 20 adds four signals (c2, c2+τ, c2+2τ, c2+3τ) and outputs the added one.

An equalizing filter 15 performs filtering on a signal d1 output from the delay adding circuit 10. The equalizing filter 15 is, for example, a 4th or 5th order low-pass Thomson or Bessel filter, and the cutoff frequency (treble cutoff frequency) is “(f₀×0.7 to 0.8)/2”. Waveform distortion is smoothed and a waveform is formed by the equalizing filter 15. A data recovery circuit 16 discriminates that whether the each bit of a signal e1 output from the equalizing filter 15 is “0” or “1”.

The structures and the operations of the equalizing filter 25 and the data recovery circuit 26 are the same in the equalizing filter 15 and the data recovery circuit 16. That is, the equalizing filter 25 performs filtering on a signal output from the delay adding circuit 20. The data recovery circuit 26 discriminates a signal output from the equalizing filter 25.

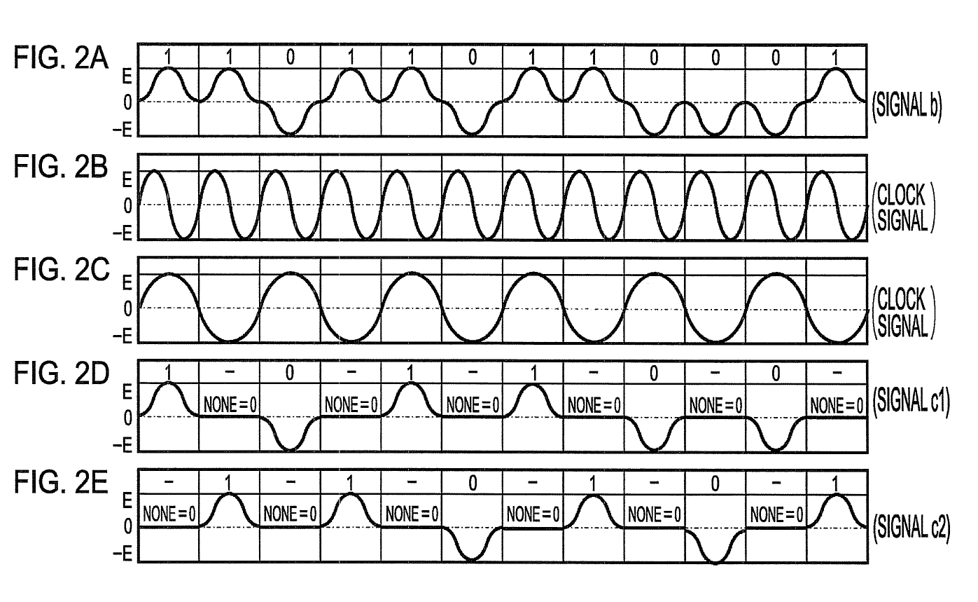

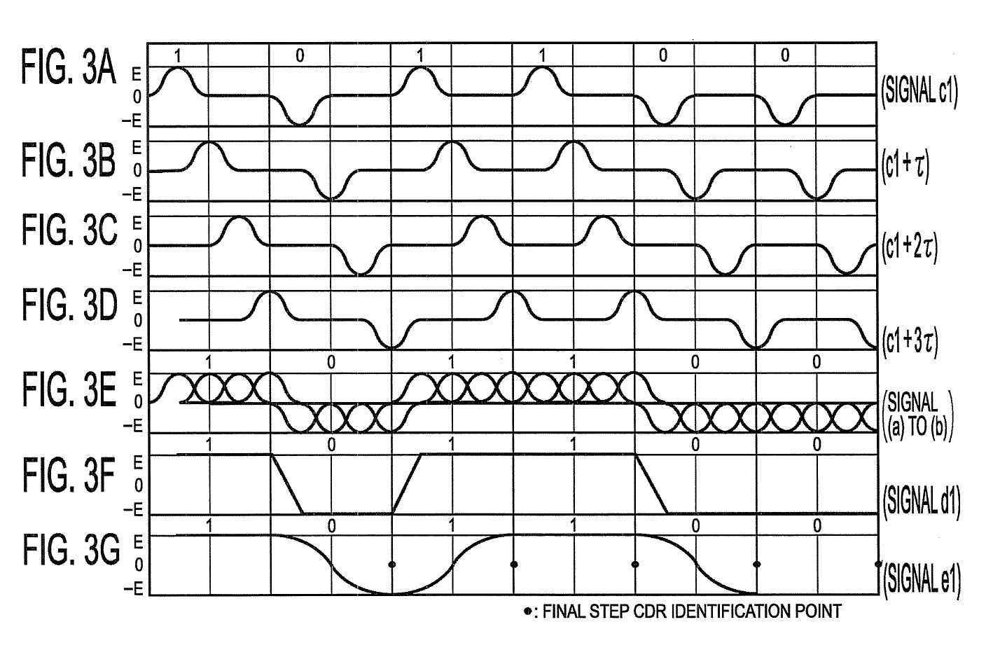

FIGS. 2A-2E and FIGS. 3A-3G are diagrams illustrating an operation of the demodulation circuit of the embodiment. Note that FIGS. 2A-2E illustrate an operation of the analog pulse selector 4, and FIGS. 3A-3G illustrate an operation of the delay adding circuit 10.

The signal b input to the analog pulse selector 4 is obtained by an optical detector (320A or 320B) illustrated in FIG. 24. For example, the signal a output from the optical detector shall be a positive electric potential when data bit is “1” and shall be a negative electric potential when data bit is “0”. The signal a is amplified by the liner amplifier 1 and filtered by the equalizing filter 2, and is input to the analog pulse selector 4. However, the optical signal transmitted from the optical transmitter is an optical RZ-DQPSK signal whose intensity is modulated. Accordingly, as illustrated in FIG. 2A, the signal b input to the analog pulse selector 4 becomes a positive pulse when the data bit is “1”, and becomes a negative pulse when the data bit is “0”. That is, the signal b is an RZ code signal.

The analog pulse selector 4 alternately introduces the pulse of the signal b into the delay adding circuits 10, 20 for every bit by using the clock signal illustrated in FIG. 2B. The frequency of the clock signal illustrated in FIG. 2B is “f₀”. In this case, the analog pulse selector 4 switches the output channel at the timing of a rising edge (falling edge) of the clock signal.

The analog pulse selector 4 may alternately introduces the pulse of the signal b to the delay adding circuits 10, 20 for every bit by using the clock signal illustrated in FIG. 2C. The frequency of the clock signal illustrated in FIG. 2C is “f₀/2”. In this case, the analog pulse selector 4 switches the output channel depending on the polarity of the electric potential level of the clock signal (whether positive electric potential or negative electric potential). In the example illustrated in FIGS. 2A-2E, when the electric potential of the clock signal is positive, the signal is introduced to the delay adding circuit 10, and when the electric potential of the clock signal is negative, the signal is introduced to the delay adding circuit 20.

FIG. 2D illustrates the signal c1 that is introduced to the delay adding circuit 10, and FIG. 2E illustrates the signal c2 that is introduced to the delay adding circuit 20. In the embodiment, pulses corresponding to the first, third, fifth, . . . bits of the signal b are introduced to the delay adding circuit 10 as the signal c1, and pulses corresponding to the second, fourth, sixth, . . . bits of the signal b are introduced to the delay adding circuit 20 as the signal c2. Note that the electric potential of the time domain in which no pulse exists is zero in the signals c1, c2.

FIGS. 3A to 3B respectively illustrated the signals c1, c1+τ, c1+2τ, c1+3τ provided to the adding circuit 14 of the delay adding circuit 10. FIG. 3E illustrates the overlapped four signals illustrated in FIGS. 3A to 3D. FIG. 3F illustrates the signal d1 obtained by adding the four signals illustrated in FIGS. 3A to 3D. The signal d1 illustrates “1, 0, 1, 1, 0, 0, . . . ” in NRZ code of a double current system. That is, the delay adding circuit 10 converts the signal c1 of RZ code to the signal d1 of NRZ code. However, one bit time of the signal d1 is double of the one bit time of the signal b.

Similarly, the delay adding circuit 20 converts the code of the signal c2 to NRZ code. At this time, one bit time of the NRZ code signal output from the delay adding circuit 20 is also double of one bit time of the signal b.

FIG. 3G illustrates the signal e1 obtained by performing filtering on the signal d1 with the equalizing filter 15. The data recovery circuit 16 identifies each bit of the signal e1 by using a discrimination clock signal. The frequency of the discrimination timing is “2/f₀”. With the discrimination, the data of the signal c1 is recovered. Similarly, the data of the signal c2 is recovered in the data recovery circuit 26. Accordingly, the data of the signal b1 is recovered by the data recovery circuits 16, 26.

In this manner, in the demodulation circuit of the embodiment, one bit time is extended double by the delay adding circuits 10, 20. That is, the transmission rate of the data which should be recovered is substantially lowered to one-half. Accordingly, even when the data rate transmitted by an optical DQPSK transmission system is extremely high, the band required for the equalizing filters 15, 25 is lowered. Accordingly, waveform distortion can be fully corrected. That is, resistance to waveform distortion is improved. Further, the S/N ratio can be improved with an existing electric circuit. Further, the operational speed to be required is lowered also for a circuit at the post-stage of the data recovery circuit.

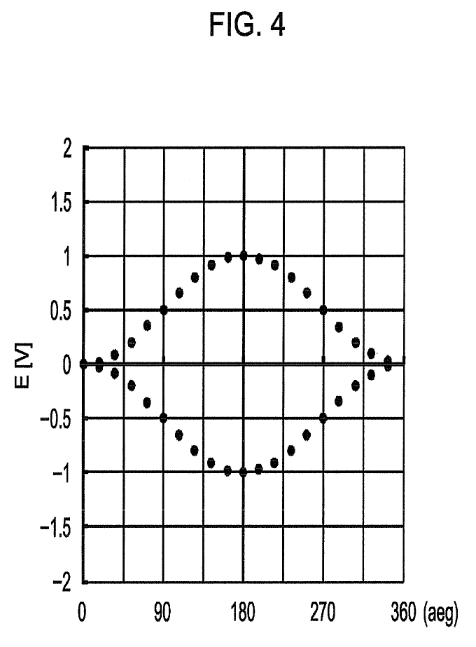

FIGS. 4 to 6 are diagrams illustrating a simulation result of an eye diagram of a waveform response. FIG. 4 is an eye diagram illustrating the signal b input to the analog pulse selector 4. Herein, one bit time T is illustrated by phase 0° to 360°. Further, the electric potential (or electrical intensity) of the signal is normalized. Further, the transmission data is M series PRBS9 MARK ½.

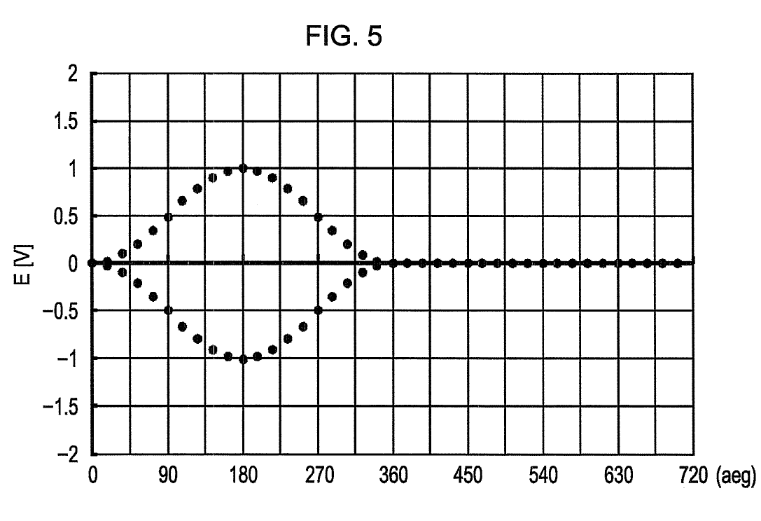

FIG. 5 is an eye diagram of the signal c1 (or c2) output from the analog pulse selector 4. The cycle of the signal c1 is 2T (0 to 720°) In the example, the pulse exists in phase 0 to 360°, and the electric potential of phase 360 to 720° is zero.

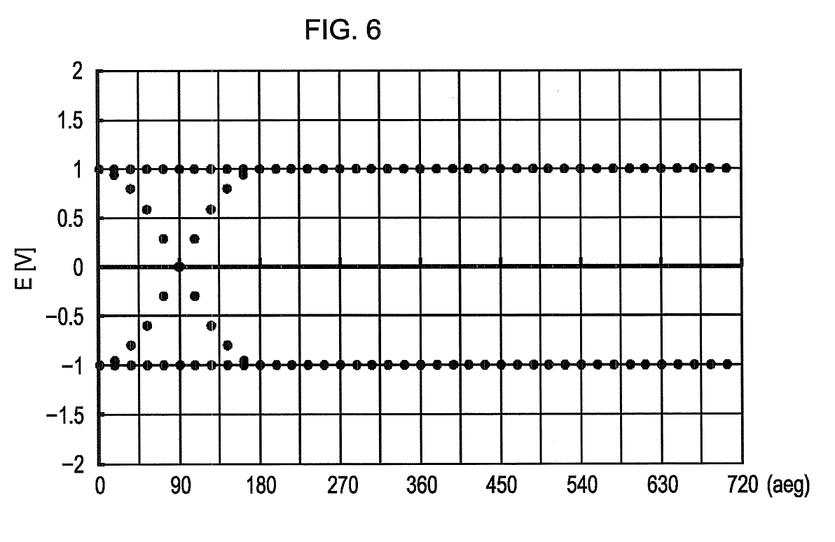

FIG. 6 is an eye diagram of the output signal of the delay adding circuit 10. The cross point of the signal is positioned at phase 90° when ignoring circuit delay. That is, the cross pint is delayed by T/4 with respect to the input signal b. The signal is filtered by the equalizing filter 15 and input to the data recovery circuit 16. The data recovery circuit 16 performs discrimination at a timing based on the aforementioned delay. In the example, the signal is discriminated at phase 450° as an example.

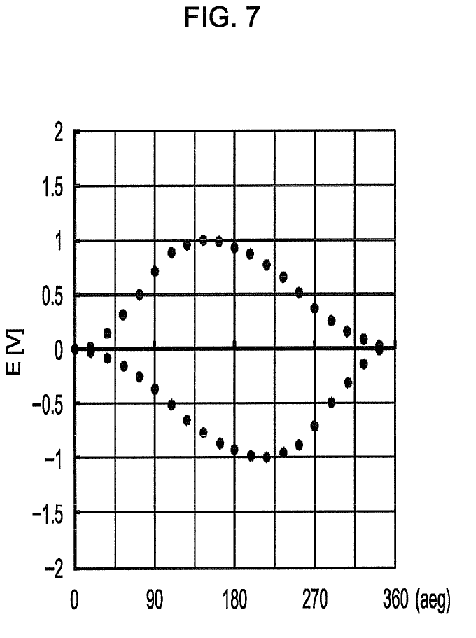

FIGS. 7 to 9 are diagrams illustrating a simulation result of eye diagrams when the input waveform is distorted. Herein, as illustrated in FIG. 7, the case is illustrated in which the rise time is long with respect to the fall time. In the example illustrated in FIG. 7, the rise time (0 to 100%) is T/3, and the fall time (100 to 0%) is T2/3. Note that such a wavelength distortion is generated by wavelength dispersion.

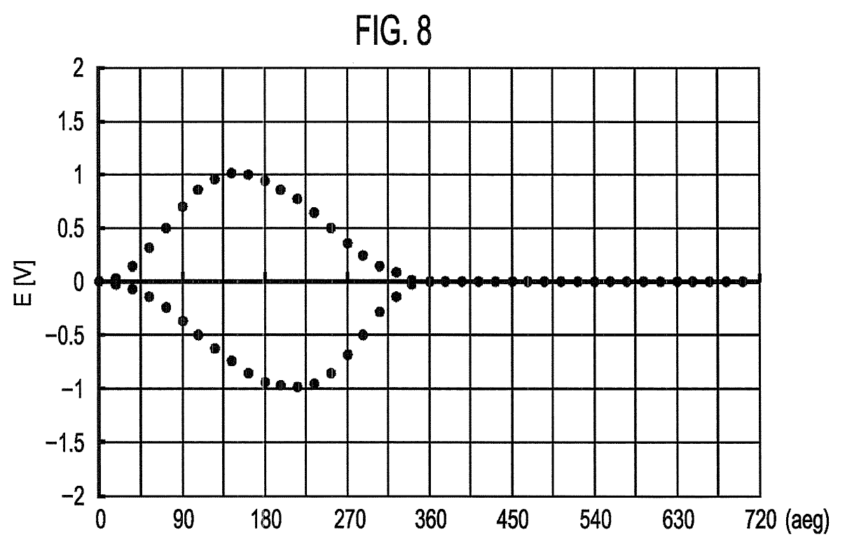

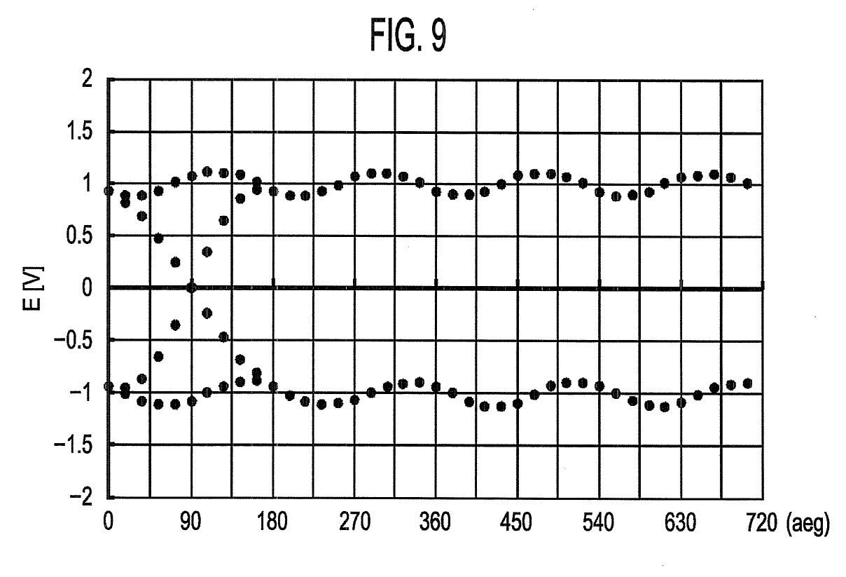

FIG. 8 is an eye diagram of the signal c1 (or c2) when the signal b illustrated in FIG. 7 is input. Then, FIG. 9 is an eye diagram of an output signal of the delay adding circuit 10 when the signal b illustrated in FIG. 7 is input. The waveform distortion (fluctuation of electric potential) illustrated in FIG. 9 is restrained by the equalizing filter 15. Accordingly, a sufficiently large eye opening can be assured, and resistance to waveform distortion and the S/N ratio are improved. That is, resistance to wavelength dispersion is improved.

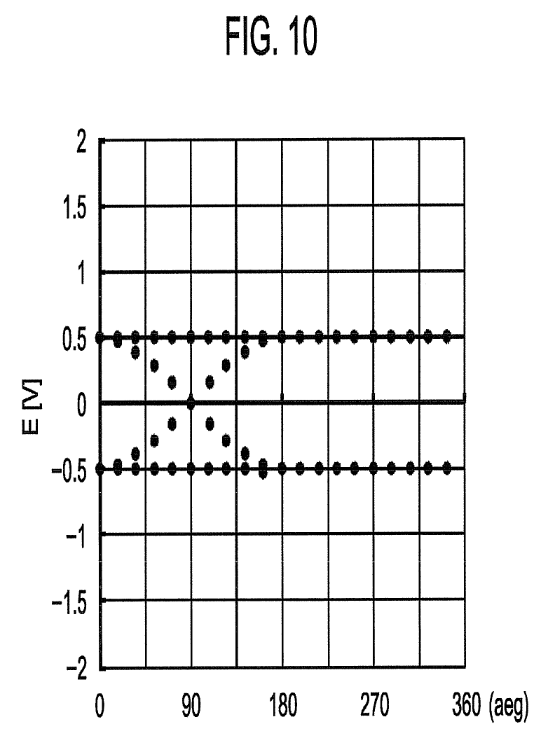

FIGS. 10 to 12 are diagrams illustrating a simulation result of eye diagrams when the input waveform is distorted by polarization dispersion. Herein, polarization dispersion generated in the optical transmission path shall be DGD (Dispersion Group Delay) corresponding to T/2. In this case, the electric potential (electrical strength) near the discrimination point of the signal b becomes 0.5E as illustrated in FIG. 10. That is, the electric potential near the discrimination pint of the signal b becomes one half as compared with the state where there is no polarization dispersion as illustrated in FIG. 4. Consequently, unless the demodulation circuit of the embodiment is used, a margin of the threshold for discriminating the signal in the data recovery circuit becomes small to deteriorate an error rate.

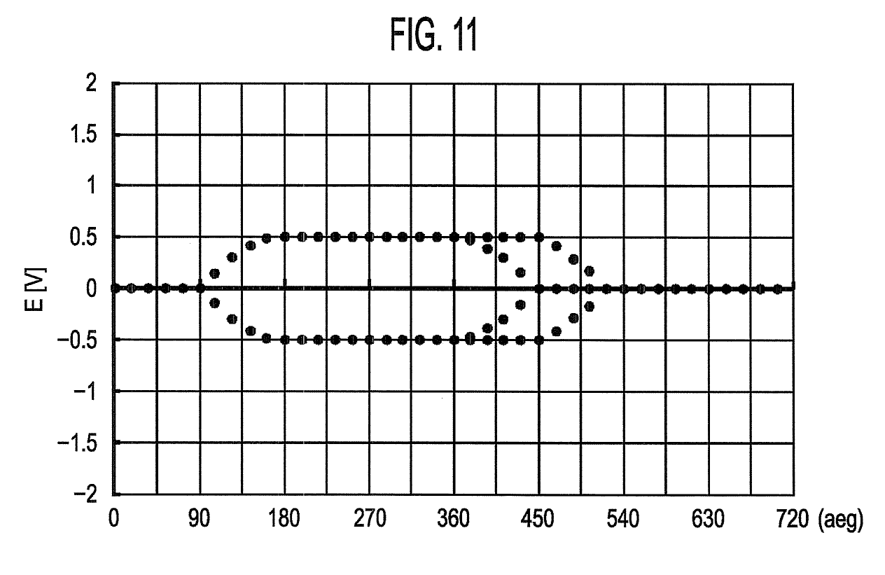

FIG. 11 is an eye diagram of the signal c1 (or c2) when the signal b illustrated in FIG. 10 is input. Herein, the signal b is an RZ code signal, and has a same code sequence pattern. Accordingly, when the response speed of the analog pulse selector is fully high, the signal c1 illustrates a waveform response that transit from zero electric potential to 0.5E (or −0.5E) electric potential in an extremely short time. However, there is a limit in an actual response speed. Accordingly, herein, in the analog pulse selector 4, the case where rise time when transited from zero electric potential to 0.5E electric potential, and fall time when transited from zero electric potential to −0.5E electric potential (0 to 100%) are T/4 is illustrated as an example. With the operation, the rise/fall of the signal c1 are overlapped.

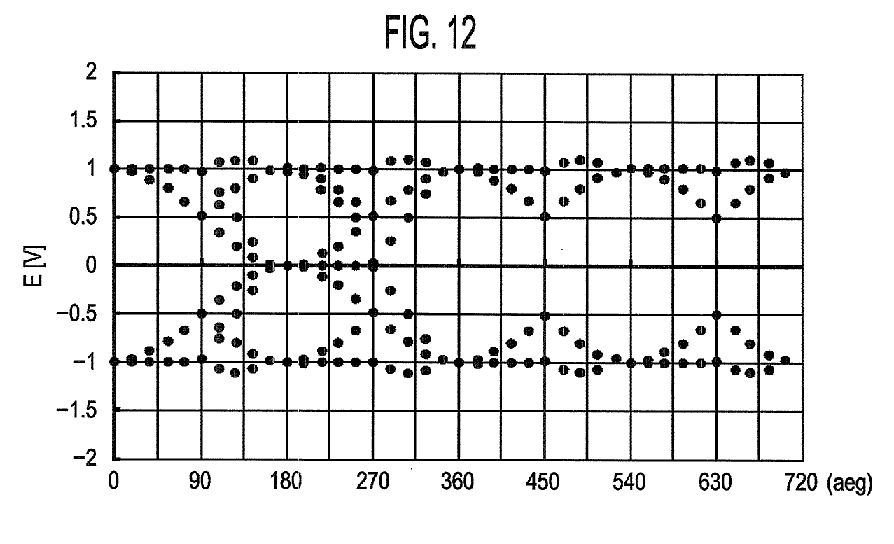

FIG. 12 is an eye diagram of an output signal of the delay adding circuit 10 when the signal b illustrated in FIG. 10 is input. A waveform distortion is remained in the signal d1 output form the delay adding circuit 10. However, when filtered by using the equalizing filter 15, the electric potential near the discrimination point becomes about ±0.7 to 0.8E. That is, by using the demodulation circuit of the embodiment, the margin of the electric potential for discriminating the signal is increased.

Note that in the aforementioned example, “DGD=T/2” shall be satisfied. However, the polarization dispersion generated in the actual system is a probability distribution as illustrated by the Maxwell distribution. That is, the actual eye diagram is more complicated as compared with the one illustrated in FIG. 12. However, by using the demodulation circuit of the embodiment, the discrimination margin is improved without change.

Further, in the demodulation circuit of the embodiment, the four pulses are added by the adding circuit 14. Herein, the S/N ratio of the pulse input to the delay circuit 10, 20 shall be [S₀/N₀]. Then, the S/N ratio of the output signal of the adding circuit 14 is [4S₀/4N₀=S₀/N₀]. That is, if the noise generated in the demodulation circuit is fully small and that can be ignored, there is no case that the S/N ratio is deteriorated in the delay adding circuits 10, 20.

On the other hand, the S/N ratio is improved by the equalizing filters 15, 25 provided at the post-stage of the delay adding circuits 10, 20. That is, when a noise contained in the signal is white color, since the bit rate of data is lowered to one-half, the equalizing filter 15, 25 can easily provides the filter property ((f₀×0.7 to 0.8)/2) that is suited for the bit rate of the data which should be discriminated by the data recovery circuit 16, 26. Consequently, a signal S is not practically reduced in the equalizing filter 15, 25. Further, the bit rate of the data of the output signal of the delay adding circuit 10, 20 is lowered to one-half, so that the frequency band of the equalizing filter 15, 25 is also one-half, and the electrical intensity of the noise is reduced to ½ times. Accordingly, according to the demodulation circuit of the embodiment, the S/N ratio is improved by about √2 times as compared with the conventional technique.

In this manner, according to the demodulation circuit of the embodiment, the bit time of the signal that should be discriminated by the data recovery circuit becomes two times of the bit time of the input signal. Accordingly, resistance to waveform distortion is increased. Further, since the band of the equalizing filter which should be provided at the pre-stage of the data recovery circuit is lowered, it becomes possible to preferably eliminate noise, and the S/N ratio is improved.

### Second Embodiment

The analog pulse selector 4 separates the signal b by using a clock signal generated from the input signal b in the demodulation circuit of the first example illustrated in FIG. 1. At this time, if the timing of the clock signal is wrong, waveform distortion occurs. Then, discrimination error in the data recovery circuit may be occurred by the waveform distortion. Accordingly, it may that the separation timing in the analog pulse selector 4 is finely adjusted.

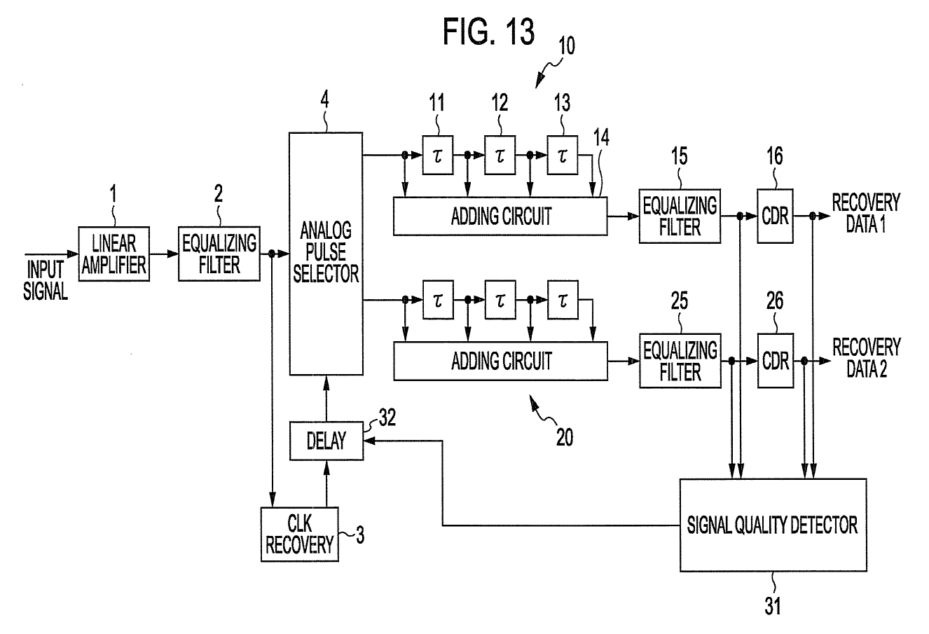

FIG. 13 is a diagram illustrating a structure of the demodulation circuit according to the second example. The structure of the demodulation circuit of a second example is basically the same as in the first embodiment. However, the demodulation circuit of the second example is equipped with a signal quality detector 31 and an adjustor (variable delay circuit) 32.

The signal quality detector 31 detects signal quality based on the input signals to the data recovery circuits 16, 26, or the recovery data output from the data recovery circuits 16, 26. When the input signals to the data recovery circuits 16, 26 are used, for example, eye opening degree, and signal spectrum are detected. Further when the recovery data is used, for example, signal spectrum, bit error rate, parity error, error correction number by forward error correction (FEC), likelihood in maximum likelihood judgment, or the like is detected. Note that the signal quality detector 31 may be constituted to include a processor.

The variable delay circuit 32 is provided between the clock recovery circuit 3 and analog pulse selector 4, and delays the clock signal generated by the clock recovery circuit 3.

In the demodulation circuit of the second example, the time delayed by the variable delay circuit 32 is adjusted by a feedback control. For example, when eye opening degree is detected, the signal quality detector 31 adjusts the delay time so that the logics of the plurality of data obtained by discriminating at a plurality of discrimination points whose voltage axis/phase axis are different are matched. When the spectrums of the input signals to the data recovery circuits 16, 26 are detected, the signal quality detector 31 adjusts delay time so that the waveform distortion becomes the minimum. When the spectrums of the output signals form the data recovery circuits 16, 26 are detected, the signal quality detector 31 adjusts the delay time so that the average value of the synchronous detection output becomes the maximum. When bit error rate, parity error, error correction number by FEC are detected, the signal quality detector 31 adjusts the delay time so that the error rate becomes the minimum.

### Third Embodiment

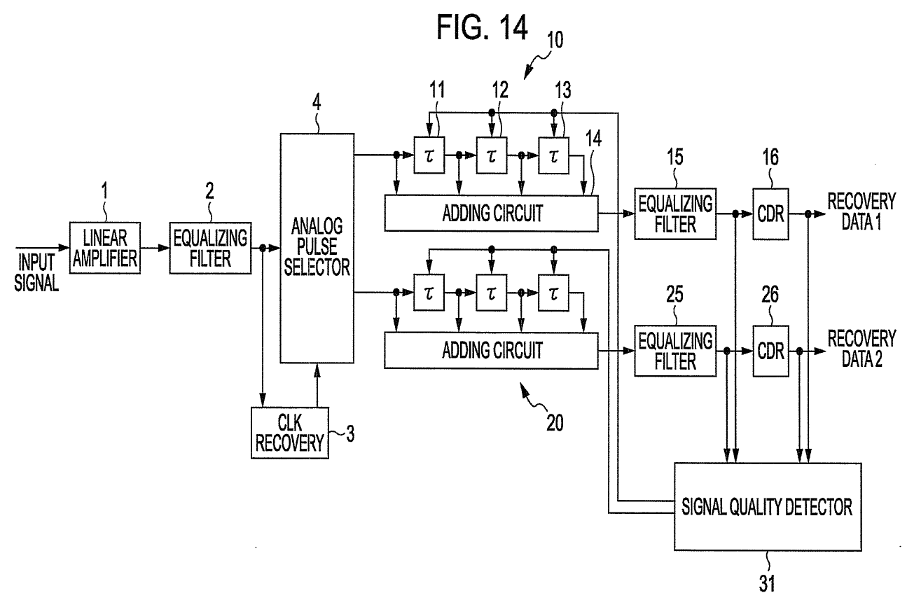

FIG. 14 is a diagram illustrating a structure of a demodulation circuit according to a third example. The structure of the demodulation circuit of the third embodiment is basically the same as in the first example. However, the demodulation circuit of the third example is equipped with the signal quality detector 31. Then, the delay time of the delay elements 11 to 13 equipped by each delay adding circuits 10, 20 can be finely adjusted by a control signal from the signal quality detector 31.

As described above, the signal quality detector 31 detects signal quality based on the input signals to the data recovery circuits 16, 26 or the recovery data output from the data recovery circuits 16, 26. Then, the delay time of the delay elements 11 to 13 equipped by the delay circuits 10, 20 is adjusted by a feed back control. The feed back control is basically the same as in the second embodiment.

### Fourth Embodiment

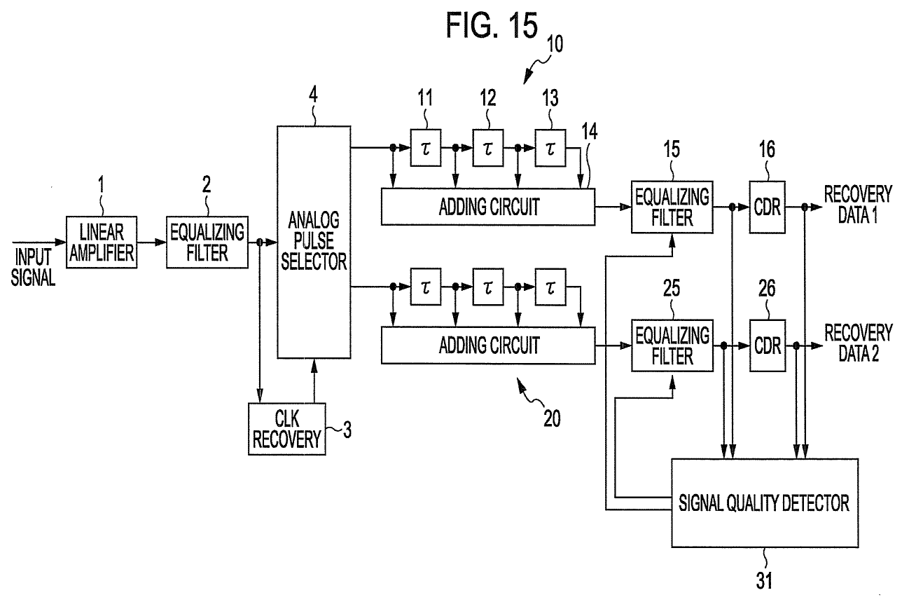

FIG. 15 is a diagram illustrating a structure of a demodulation circuit according to a fourth example. The structure of the demodulation circuit 4 of the fourth example is basically the same as in the first example. However, the demodulation circuit of the fourth embodiment is equipped with the signal quality detector 31. Then, the cutoff frequency of the equalizing filters 15, 25 can be adjusted by a control signal from the signal quality detector 31. For example, when the equalizing filters 15, 25 are constituted to include a capacitance component, the cutoff frequency can be adjusted by varying the capacitance component.

As described above, the signal quality detector 31 detects signal quality based on the input signals to the data recovery circuits 16, 26 or the recovery data output from the data recovery circuits 16, 26. Then, the cut off frequency of the equalization filters 15, 25 are adjusted by a feed back control. The feed back control is basically the same as in the second embodiment. With the structure, high order waveform distortion can be reduced, improvement of the S/N ratio can be provided, and an discrimination margin in the data recovery circuit is improved.

### Fifth Embodiment

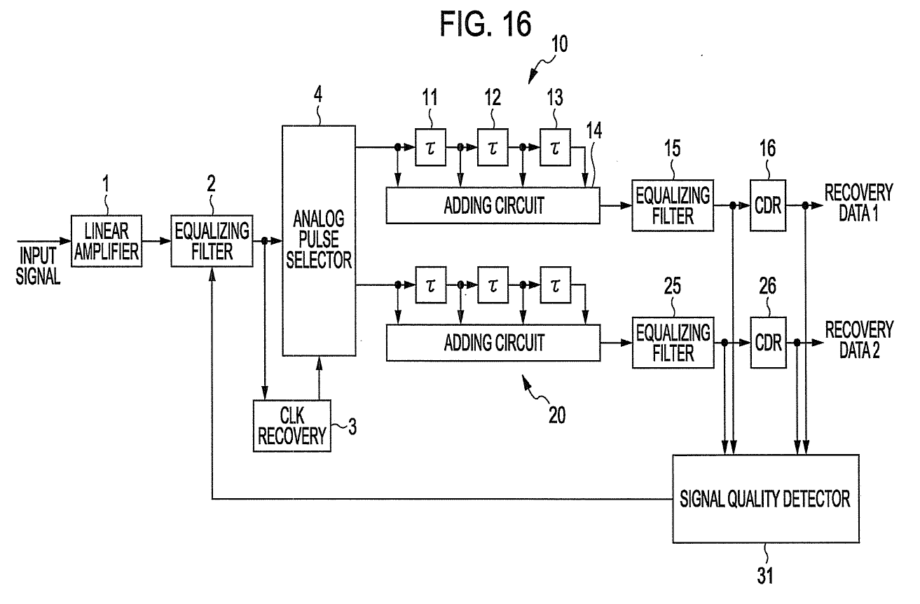

FIG. 16 is a diagram illustrating a structure of a demodulation circuit according to a fifth embodiment. The structure of the demodulation circuit of the fifth embodiment is basically the same as in the first embodiment. However, the demodulation circuit of the fifth embodiment is equipped with the signal quality detector 31. Then, the cutoff frequency of the equalizing filter 2 can be adjusted by a control signal from the signal quality detector 31. For example, when the equalizing filter 2 is constituted to include a capacitance component, the cutoff frequency can be adjusted by varying the capacitance component.

As described above, the signal quality detector 31 detects the quality of signal based on the input signals to the data recovery circuits 16, 26 or the recovery data output from the data recovery circuits 16, 26. Then, the cutoff frequency of the equalizing filter 2 is adjusted by a feedback control. The feed back control is basically the same as in the second embodiment. With the structure, high order waveform distortion of the input signal can be reduced.

### Sixth Embodiment

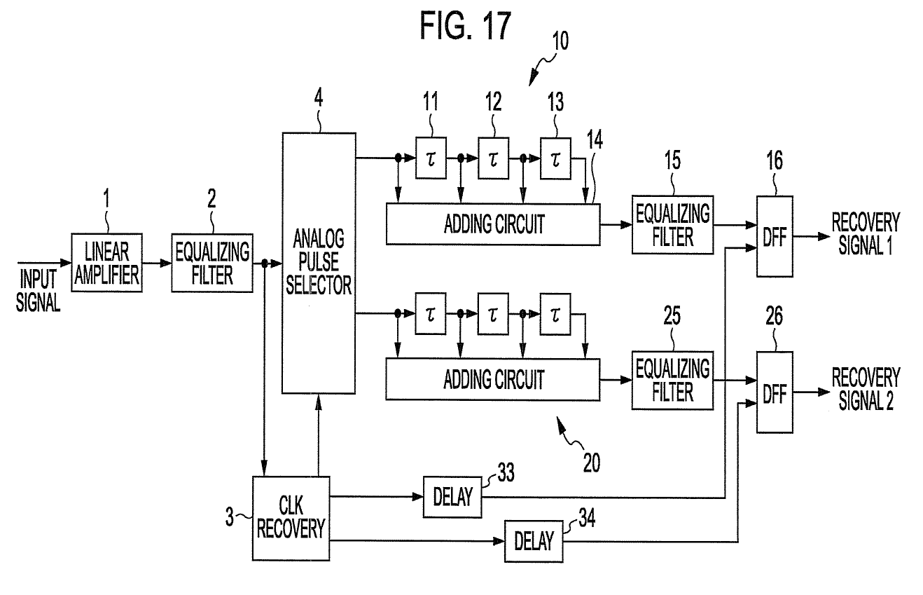

FIG. 17 is a diagram illustrating a structure of a demodulation circuit according to a sixth example. The structure of the demodulation circuit of the sixth example is basically the same as in the first embodiment. However, the demodulation circuit of the sixth example is equipped with delay elements 33, 34. Further, each of the data recovery circuits 16, 26 is a D flip-flop circuit.

The delay element 33, 34 delays a clock signal generated by the clock recovery circuit 3. The frequency of the cock signal is “f₀/2”. Further, the clock signal is generated by, for example, frequency-dividing the clock signal which should be provided to the analog pulse selector 4 by two. The clock signals whose timings are adjusted by the delay elements 33, 34 are respectively provided to the data recovery circuits 16, 26 respectively. Then, the data recovery circuits 16, 26 recover data depending on the respectively provided clock signal. With the structure, the delay time of the delay elements 33, 34 is preliminarily adjusted and fixed so that signal quality is optimized.

### Seventh Embodiment

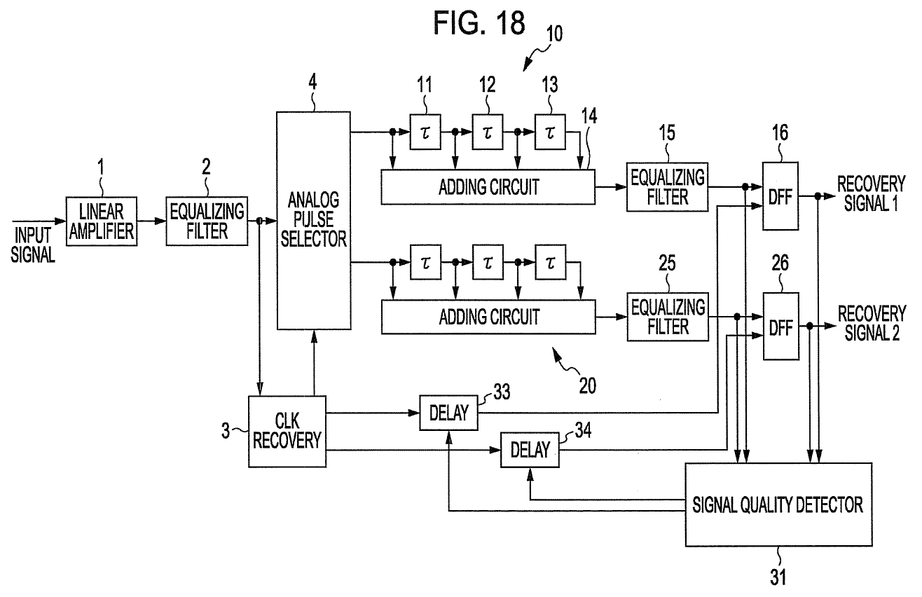

FIG. 18 is a diagram illustrating a structure of a demodulation circuit according to a seventh example. The structure of the demodulation circuit of the seventh example is basically the same as in the sixth embodiment. However, the demodulation circuit of the seventh example is equipped with the signal quality detector 31. Further, the delay time of the delay element 33, 34 can be adjusted by a control signal from the signal quality detector 31.

As described above, the signal quality detector 31 detects signal quality based on the input signals to the data recovery circuits 16, 26 or the recovery data output from the data recovery circuits 16, 26. Then, the delay time of the delay elements 33, 34 is adjusted by a feedback control. The feedback control is basically the same as in the second embodiment.

In this manner, the demodulation circuits illustrated as the second to seventh examples have additional functions with respect to the structure of the first embodiment. The additional functions can be arbitrarily combined.

### Embodiment of Optical Receiver

An optical receiver equipped with the demodulation circuit of the embodiment will be described. The optical receiver shall receive an optical RZ-2ⁿPSK (n is an integer not less than two) signal and recover data. Hereinafter, an optical receiver that receives an optical RZ-DQPSK (that is, n=2) signal will be described.

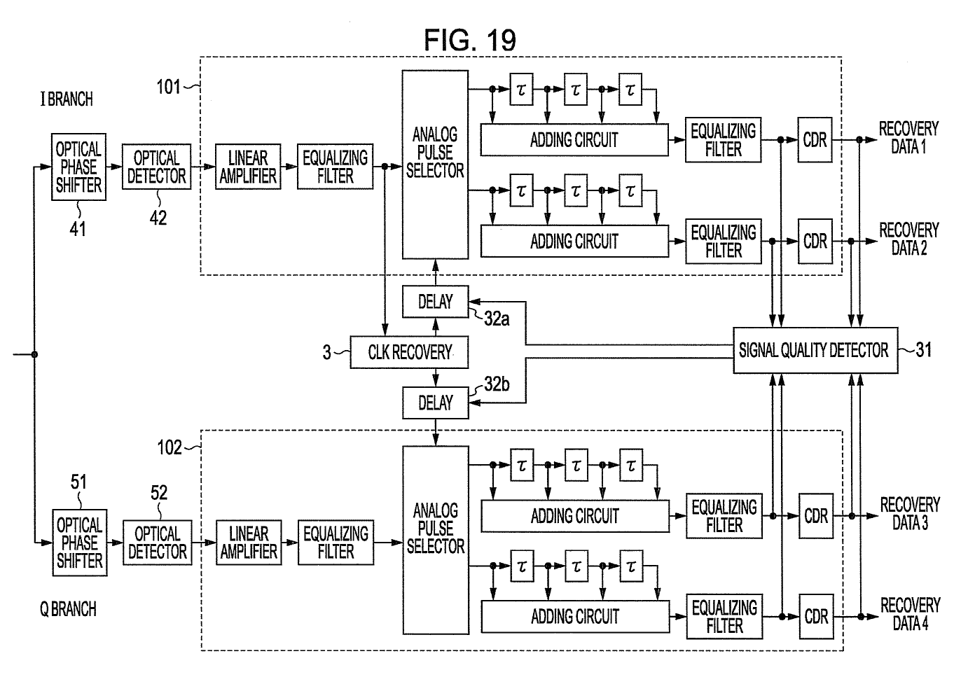

FIG. 19 is a diagram illustrating an optical receiver equipped with the demodulation circuit of the embodiment. The optical receiver is equipped with a demodulation circuit 101 for demodulating an I branch signal, and a demodulation circuit 102 for demodulating a Q branch signal. The demodulation circuits 101, 102 have the same structure to each other. Herein, the demodulation circuit of the aforementioned first example shall be used. Note that the clock recovery circuit 3 and the signal quality detector 31 are shared by the demodulation circuits 101, 102.

An input optical RZ-DQPSK signal is branched and introduced to an I branch and a Q branch. An optical phase shifter 41, 51 corresponds to, for example, the delay interferometer 310A, 310B illustrated in FIG. 24, and respectively generates an optical signal based on a phase difference between symbols adjacent to each other. An optical detector 42, 52 corresponds to, for example, the balanced optical detector (TWIN-PD) 320A, 320B illustrated in FIG. 24, and respectively converts an optical signal output from the optical phase shifter 42, 52 to an electrical signal. Then, the electrical signals obtained by the optical detectors 42, 52 are respectively input to the demodulation circuits 101, 102.

The demodulation circuit 101 obtains recovery data 1, 2 from the input signal of the I branch. Similarly, the demodulation circuit 102 obtains recovery data 3, 4 from the input signal of the Q branch. Then, transmission data can be obtained from the recovery data 1 to 4.

The clock recovery circuit 3 recovers a clock signal from the input signal of the I branch. The recovered clock signal is provided to the analog pulse selectors of the both I branch and Q branch. A delay element 32a delays the cock signal that should be provided to the analog pulse selector of the I branch, and a delay element 32b delays the clock signal that should be provided to the analog pulse selector of the Q branch. Then, the signal quality detector 31 adjusts the delay time of the delay elements 32a, 32b so that signal quality is optimized. According to the structure, the operation timings of the analog pulse selectors of the I branch and Q blanch can be matched to each other.

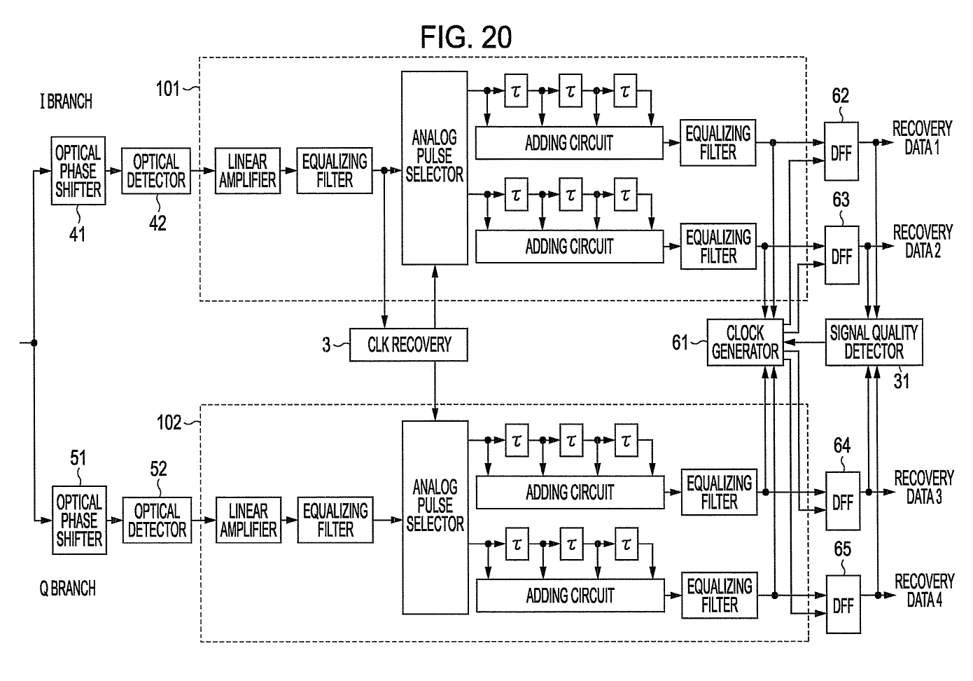

FIG. 20 is a diagram illustrating another structure of an optical receiver equipped with the demodulation circuit of the embodiment. In FIG. 20, a clock recovery circuit 61 recovers a clock signal from an output signal of one or a plurality of equalizing filter provided at the post-stage of the delay adding circuit. The clock signal is provided to a pair of data recovery circuits (for example, D flip-flop) 62, 63 equipped by the demodulation circuit 101 and a pair of data recovery circuits (for example, D flip-flop) 64, 65 equipped by the demodulation circuit 102. Each data recovery circuit 62 to 65 identifies a signal by using the clock signal to recover data. Then, the signal quality detector 31 adjusts the timing of the clock signal that should be provided to each data recovery circuit 62 to 65 so that signal quality is optimized. According to the structure, the recovery timings of the four data recovery circuits 62 to 65 can be matched to each other.

Note that the optical receiver according to the embodiment may be equipped with the both functions illustrated in FIGS. 19 and 20.

Modifications and the Like

The demodulation circuit illustrated in the aforementioned embodiment has two delay adding circuits, and the analog pulse selector 4 separates an input signal by time division to introduce the separated signals to the two delay adding circuits. However, the invention is not limited to the structure, and not less than three delay adding circuits may be equipped.

Further, three delay elements are equipped and delay time τ of each delay element is “½f₀” in the delay adding circuit illustrated in the aforementioned embodiment. However the embodiment is not limited to the structure, and the number and delay time τ of the delay elements can be modified. However, when the number of the delay elements is m, it is preferable to satisfy the following condition “τ(m+1)=2/f₀”

Further, the linear amplifier 1, the equalizing filter 2, the equalizing filters 15, 16 are not indispensable constituent elements. That is, the signal obtained by the optical detector may be directly provided to the analog pulse selector 4, or output signals of the delay adding circuits 10, 20 may be directly provided to the data recovery circuits 16, 26.

### Embodiment of PCM Receiving Circuit

The demodulation circuits of the aforementioned first to seventh examples can be operated as a coding circuit that converts the code of a PCM code signal. Hereinafter, the coding circuit that converts a PCM code signal to an NRZ code signal will be described.

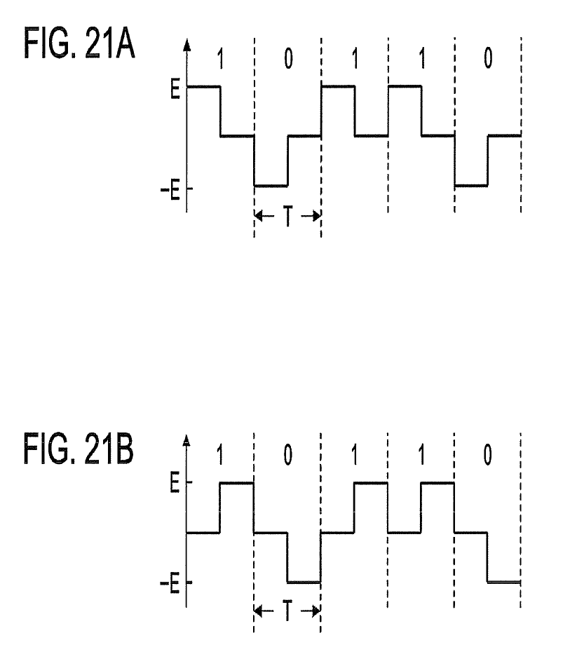

The coding circuit of the embodiment converts, for example, the PCM coding signal illustrated in FIGS. 21A and 21B to an NRZ coding signal. The PCM coding signal illustrated in FIGS. 21A and 21B indicates logic 1 by the combination of positive electric potential “+E” and electric potential zero, and indicates logic 0 by the combination of negative electric potential “−E” and electric potential zero. In FIGS. 21A and 21B, the time T corresponds to one bit time. In the PCM coding signal illustrated in FIG. 21A, “1” bit is indicated by “E” of one-half bit time followed by “zero” of one-half bit time, and “0” bit is indicated by “−E” of one-half bit time followed by “zero” of one-half bit time. On the other hand, in the PCM coding signal illustrated in FIG. 21B, “1” bit is indicated by “zero” of one-half bit time followed by “+E” of one-half bit time, and “0” bit is indicated by “zero” of one-half bit time followed by “−E” of one-half bit time.

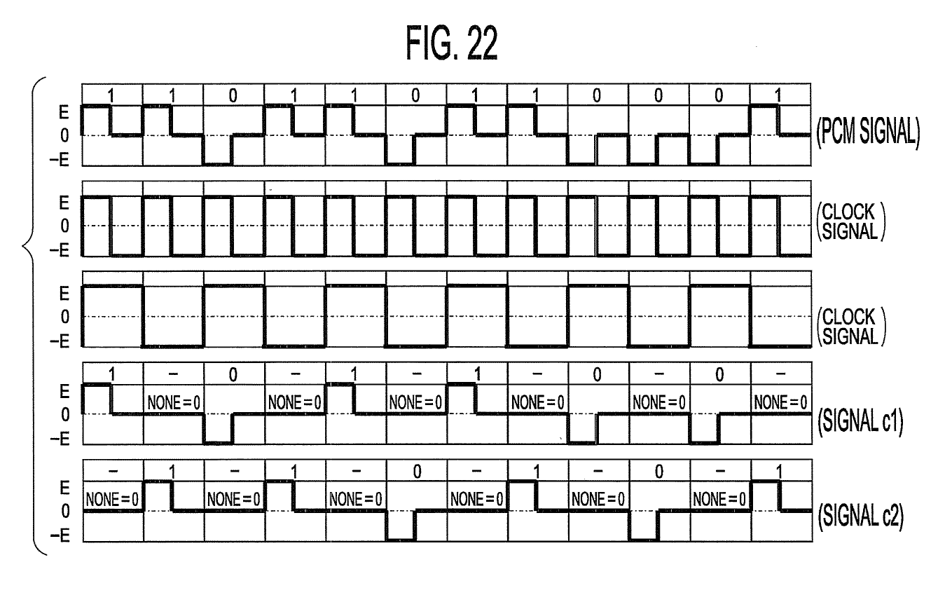

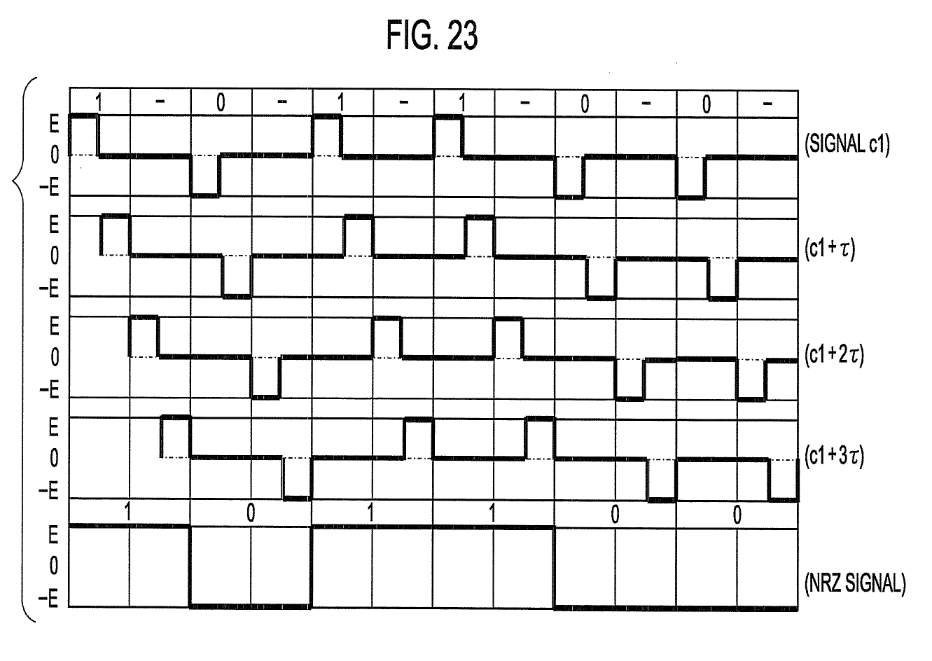

FIGS. 22 to 23 are diagrams illustrating an operation of the coding circuit. Note that FIG. 22 illustrates a separating operation by the analog pulse selector 4, and FIG. 23 illustrates a delay adding operation by the delay adding circuit 10.

The operation illustrated in FIGS. 22 to 23 is basically the same as the demodulation operation described with reference to FIGS. 2 to 3. That is, an input PCM code signal is separated for every bit to be introduced to the delay adding circuits 10, 20. The delay adding circuit 10, 20 generates an NRZ code bit having the double bit time as compared with the input PCM code signal by adding each pulse (P) to the delay component (P+τ, P+2τ, p+3τ). Note that the code converting operation can be performed by the analog pulse selector and the plurality of delay adding circuits.

According to embodiments of the disclosed demodulation circuits, transmission data can be recovered with high dimensional accuracy even for a signal having a high transmission rate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A demodulation circuit for reproducing transmitted data from a signal received by a receiver, the demodulation circuit comprising:
a selector for demultiplexing the transmitted data into a plurality of divided signals;
a plurality of converters for receiving the divided signal from the selector, respectively, the plurality of converters including a delay device and an adding circuit, the delay device for delaying the divided signal from the selector and for outputting a delayed signal, the adding circuit for adding the divided signal from the selector to the delayed signal from the delay device; and
a plurality of data recovery circuits for receiving an output signal from the adding circuits, respectively, each of the data recovery circuits discriminating the output signal from the adding circuit.

2. The demodulation circuit of claim 1, wherein the selector is a 1:2 demultiplexer for separating the transmitted data by time division.

3. The demodulation circuit of claim 1, wherein the delay element includes a first delay element, a second delay element and a third delay element being connected in series connection, each of the delay element providing one-half of the one bit time of the transmitted data.

4. The demodulation circuit of claim 1, further comprising:
a detector for detecting signal quality on the bases of the output signal from the adding circuits or an output signal from the data recovery circuit; and
an adjustor for adjusting a separation timing of the selector on the bases of an output of the detector.

5. The demodulation circuit of claim 1, further comprising a detector for detecting signal quality on the bases of the output signal from the adding circuits or an output signal from the data recovery circuit, and for controlling the delay of the delay device.

6. The demodulation circuit of claim 1, further comprising:
a equalizing filter arranged between the converter and data recovery circuit;
and having a cutoff frequency, and
a detector for detecting signal quality on the bases of the output signal from the adding circuits or an output signal from the data recovery circuit, and for controlling the cutoff frequency of the equalizing filter.

7. The demodulation circuit of claim 1, further comprising:
a equalizing filter arranged before the selector, and having a cutoff frequency, and
a detector for detecting signal quality on the bases of the output signal from the adding circuits or an output signal from the data recovery circuit and for controlling the cutoff frequency of the equalizing filter.

8. The demodulation circuit of claim 1,
further comprising a clock recovery circuit for providing a clock to the selector in order to set a separation timing of the selector;
wherein the data recovery circuits recovers the data by the use of the clock from the clock generation circuit.

9. The demodulation circuit of claim 1, further comprising:
a detector for detecting signal quality on the bases of the output signal from the adding circuits or an output signal from the data recovery circuit;
a clock recovery circuit for providing a clock to the selector in order to set a separation timing of the selector;
an adjustor for adjusting a clock timing of the clock from the clock generation circuit on the bases of an output of the detector.

10. The demodulation circuit of claim 1, wherein the signal is an optical RZ-PSK signal.

11. The demodulation circuit of claim 1, wherein the signal is an optical RZ-2ⁿPSK signal, the suffix “ⁿ” is more than one integral number.

12. The demodulation circuit of claim 1, wherein the signal is an optical RZ-2ⁿPSK signal, the suffix “ⁿ” being more than one integral number.

13. The demodulation circuit of claim 12,
wherein the signal is PCM code signal being indicative a logic “1” by the combination with electropositive potential and zero potential, and logic “0” by the combination with electronegative potential and zero potential;
wherein the PCM code signal is change into NRZ code signal.

14. A receiver for reproducing transmitted data from a signal inputted itself, the optical receiver comprising:
an I branch demodulation circuit; and
a Q branch demodulation circuit;
wherein the I branch demodulation circuit and Q branch demodulation circuit includes:
a selector for demultiplexing the transmitted data into a plurality of divided signals;
a plurality of converters for receiving the divided signal from the selector, respectively, the plurality of converters including a delay device and an adding circuit, the delay device for delaying the divided signal from the selector and for outputting a delayed signal, the adding circuit for adding the divided signal from the selector to the delayed signal from the delay device; and
a plurality of data recovery circuits for receiving an output signal from the adding circuits, respectively, each of the data recovery circuits discriminating the output signal from the adding circuit.

15. The optical receiver of claim 14, further comprising:
a detector for detecting signal quality on the bases of the output signal from the adding circuits or an output signal from the data recovery circuit; and
a clock recovery circuit for providing a clock to the selector in order to set a separation timing of the selector; and
an adjustor for adjusting a separation timing of the selector on the bases of an output of the detector.

16. The optical receiver of claim 14, further comprising:
a detector for detecting signal quality on the bases of the output signal from the adding circuits or an output signal from the data recovery circuit; and
a clock recovery circuit for providing a clock to the data recovery circuits in order to adjust the clock timing.
